(19) United States
(12) Patent Application Publication
(10) Pub. No.: US 2015/0294529 A1
(43) Pub. Date: Oct. 15, 2015

(54) System and Method for Controlling Reel Motion in a Spinning Reel Gaming Machine

(71) Applicant: WMS Gaming Inc., Waukegan, IL (US)

(72) Inventors: Timothy C. Loose, Chicago, IL (US); Philip J. Weiss, Mokena, IL (US)

(73) Assignee: WMS Gaming Inc., Waukegan, IL (US)

(21) Appl. No.: 14/249,110

(22) Filed: Apr. 9, 2014

(51) Int. Cl. G07F 17/32; G07F 17/34

(52) U.S. Cl. CPC G07F 17/3213; G07F 17/34

(57) ABSTRACT

A method for conducting a wagering game includes the act of providing a set of motion parameters to a mechanical reel controller of a wagering game machine, the set of motion parameters including one or more start profiles, a plurality of motion profiles, and one or more stop profiles. The method also includes the act of determining, using one or more processors, a set of motion parameters for each of the mechanical reels that will collectively place the mechanical reels in sync prior to execution of the stop profile(s) so that each of the plurality of mechanical reels is positioned relative to one another, during rotation, to display a determined outcome of the wagering game. The method includes the acts of driving each reel in accord with a respective start profile(s), driving each reel in accord with respective motion profile(s) and stopping each reel in accord with respective stop profile(s) at a point in time after the plurality of mechanical reels are in sync.

### FIELD OF THE INVENTION

The present invention relates generally to gaming machines, and more particularly, to spinning reel type gaming machines.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

In general, standard mechanical gaming machines include a plurality of reels with symbols around the perimeters of the reels. In the course of normal game play the reels are spun and stopped at a given reel stop position. Stepper motors, through the use of a motor controller and under the control of the gaming machine firmware, drive the reels. Stepper motors, or steppers, have been described as electric motors without commutators. Steppers consist of a plurality of windings that are all part of a stator and a rotor that may be a permanent magnet. For variable reluctance motors, the rotor may be a toothed block of a magnetically soft material. A motor controller externally handles the commutation. Design of these motors and controllers allows the motor to be held in a fixed position as well as being rotated.

The motor spins as the coils are driven in a sequence specified by the manufacturer. The rate at which the coils are sequenced determines the angular velocity of the motor. Changes in angular velocity of the reel-motor combination are limited by the moment of inertia of the motor and reel, along with the torque of the motor. Because of this limitation, the motor must be accelerated to its terminal velocity over some period of time. FIG. 5A shows a typical sequence that can be used in a gaming machine such as gaming machine 10 of FIG. 1, where gaming machine 10 has mechanical reels 12.

### SUMMARY OF THE INVENTION

In various embodiments set forth herein, the present concepts include a wagering game system and methods for conducting wagering games on the wagering game system in which one or more reels are driven based on reel spin motion parameters comprising one or more motion profiles wherein a velocity of the one or more reels is adjusted, following attainment of a constant running speed, to control a distance traveled by the one or more reels in a manner that aligns the plurality of reels in sync to reveal the outcome determined for the wagering game.

According to one aspect of the present invention, a wagering game system configured to conduct a wagering game, the wagering game system comprising one or more input devices, one or more reel controllers and one or more display devices, the one or more display devices including a plurality of mechanical reels, each of the plurality of mechanical reels bearing a plurality of symbols used to display a determined outcome of the wagering game and each of the plurality of mechanical reels being independently driven by a respective reel driver. The wagering game system also includes game-logic circuitry, comprising one or more central processing units and one or more memory devices, the one or more physical memory devices storing instructions that, when executed by the one or more central processing units, cause the game-logic circuitry and reel controllers, as appropriate, to perform various functions associated with the wagering game. The game-logic circuitry and reel controllers are configured to register an input from at least one of the one or more input devices an indication of a wager to conduct the wagering game, cause the reel drivers to accelerate each of the plurality of mechanical reels to a first constant running speed using a common start profile, and cause a reel driver to drive a respective one of the plurality of mechanical reels, following attainment of the first constant running speed, to a second constant running speed in accord with a first reel spin adjustment profile and then to drive the one of the plurality of mechanical reels back to the first constant running speed. The game-logic circuitry and reel controllers are further configured to cause the reel drivers to decelerate each of the plurality of mechanical reels from the first constant running speed to a stop using a common stop profile to display the outcome of the wagering game.

According to another aspect of the present invention, a gaming machine is configured to conduct a wagering game comprising one or more input devices to receive inputs to play a wagering game, a first reel controller, a first reel on which a plurality of wagering game symbols associated with the game are portrayed, and a first reel driver responsive to a plurality of drive signals from the first reel controller to drive the first reel based on motion parameters associated with a spin profile for the first reel, the motion parameters including an start profile, a motion profile, and a stop profile. The gaming machine also includes one or more central processing units and one or more memory devices operatively coupled to the one or more central processing units via a data bus. Information regarding the motion parameters is provided to the first reel controller using the data bus, the motion parameter start profile comprising acceleration of the first reel from a stop to a first constant running speed. The motion parameter motion profile for the first reel comprises one or acceleration or deceleration of the first reel from the first constant running speed to a second constant running speed, maintenance of the second constant running speed for a second predetermined period of time, and a corresponding other one of deceleration or acceleration of the first reel, as appropriate, back to the first constant running speed following lapse of the second predetermined period of time. The motion parameter stop profile comprises deceleration of the first reel from the first constant running speed to a stop to display the contribution of the first reel's displayed wagering game symbols to the outcome of the wagering game.

According to another aspect of the invention, a computer-implemented method in a gaming system for conducting a wagering game on a wagering game system includes the act of providing a set of motion parameters in a reel controller of a gaming machine, the gaming machine having an input device to receive a wager to play a game and a plurality of reels each portraying a plurality of symbols associated with the wagering game, the set of motion parameters including one or more start profiles, one or more motion profiles, and one or more stop profiles. The computer-implemented method also includes the acts of determining an outcome of the wagering game responsive to the wager using one or more processors and determining, using the one or more processors, a set of motion parameters for each of the plurality of reels that will collectively place each of the reels in sync at a predetermined constant running speed during the conduct of the respective one or more motion profiles, so that each of the plurality of reels is positioned, during rotation, relative to one another to display a determined outcome of the wagering game. The computer-implemented method also includes the acts of driving the plurality of reels in accord with the one or more motion profiles and stopping the plurality of reels in accord with the one or more stop profiles.

In accord with other aspects of the present concepts, a method for conducting a wagering game on a wagering game machine having an input device to receive a wager to play the wagering game and having a plurality of mechanical reels, each of the plurality of mechanical reels portraying a plurality of symbols associated with the wagering game, includes the acts of determining an outcome of the wagering game using one or more processors and providing a set of motion parameters to a mechanical reel controller, the set of motion parameters including one or more start profiles, a plurality of motion profiles, and one or more stop profiles. The method further includes providing a set of motion parameters to a mechanical reel controller for the wagering game machine, the set of motion parameters including one or more start profiles, a plurality of motion profiles, and one or more stop profiles and of determining, using one or more processors, a set of motion parameters for each of the mechanical reels that will collectively place the mechanical reels in sync prior to execution of the stop profile(s) so that each of the plurality of mechanical reels is positioned relative to one another, during rotation, to display a determined outcome of the wagering game. The method includes the acts of driving each reel in accord with a respective start profile(s), driving each reel in accord with respective motion profile(s) and stopping each reel in accord with respective stop profile(s) at a point in time after the plurality of mechanical reels are in sync.

According to yet another aspect of the invention, computer-readable storage media is encoded with instructions for directing a gaming system to perform the above method.

According to still another aspect of the invention, the above gaming system is incorporated into a single, free-standing gaming terminal.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4 shows a block diagram of a conventional gaming machine having a reel controller, a number of reels, and a number of reel drivers in which the reel controller uses spin profiles to manage the operation of the reel(s).

FIG. 5A shows a conventional spin profile velocity-time curve showing velocity of a reel at all times during a spin sequence.

FIG. 5B shows a conventional table of delay values used in a typical acceleration sequence.

FIGS. 6A-6D show conventional variants of the spin profile velocity-time curve shown in FIG. 5A.

FIGS. 7A-7B show spin profile velocity-time curves in accord with at least some aspects of the present concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

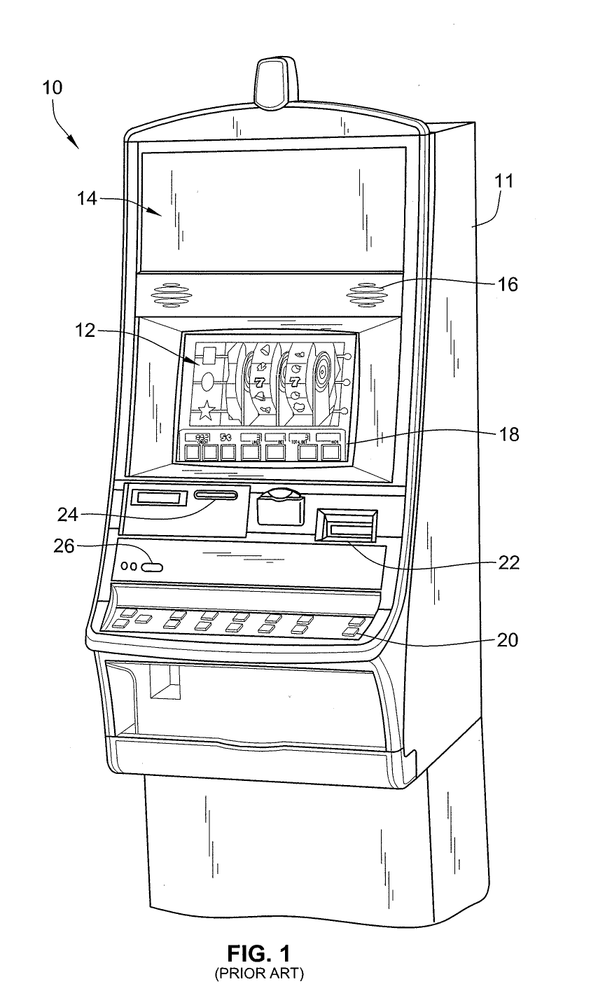

Referring to FIG. 1, there is shown a gaming machine 10 similar to those used in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in conducting wagering games, or may include non-dedicated devices, such as mobile phones, personal digital assistants, personal computers, etc. Exemplary types of gaming machines are disclosed in U.S. Pat. Nos. 6,517,433 and 7,360,761 and in Patent Application Publication Nos. US2010/0069160 and US2010/0234099, which are each incorporated herein by reference in their entireties.

The gaming machine 10 illustrated in FIG. 1 comprises a cabinet 11 that may house various input devices, output devices, and input/output devices. By way of example, the gaming machine 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

Input devices, such as the touch screen 18, buttons 20, a mouse, a joystick, a gesture-sensing device, a voice-recognition device, and a virtual-input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a game-logic circuitry for processing. The electronic data signals are selected from a group consisting essentially of an electrical current, an electrical voltage, an electrical charge, an optical signal, an optical element, a magnetic signal, and a magnetic element.

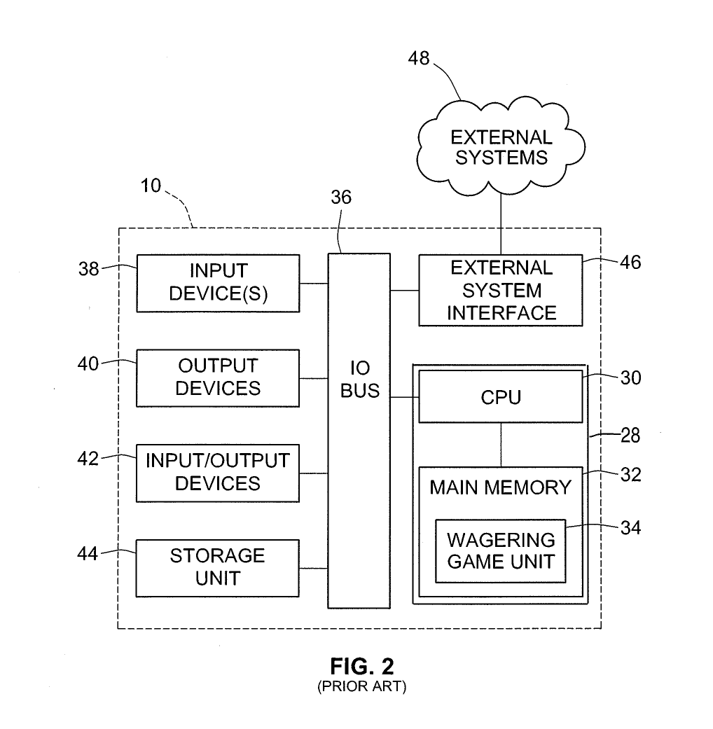

Turning now to FIG. 2, there is shown a block diagram of the gaming-machine architecture. The gaming machine 10 includes game-logic circuitry 28 having a central processing unit (CPU) 30 connected to a main memory 32. The CPU 30 may include any suitable processor(s), such as those made by Intel and AMD. By way of example, the CPU 30 may include a plurality of microprocessors including a master processor, a slave processor, and a secondary or parallel processor. Game-logic circuitry 28, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 28, and more specifically the CPU 30, comprises one or more controllers or processors and such one or more controllers or processors need not be disposed proximal to one another and may be located in different devices or in different locations. The game-logic circuitry 28, and more specifically the main memory 32, comprises one or more memory devices which need not be disposed proximal to one another and may be located in different devices or in different locations. The game-logic circuitry 28 is operable to execute all of the various gaming methods and other processes disclosed herein. The main memory 32 includes a wagering-game unit 34. In one embodiment, the wagering-game unit 34 may cause wagering games to be presented, such as video poker, video black jack, video slots, video lottery, etc., in whole or part.

The game-logic circuitry 28 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to a storage unit 44 and an external-system interface 46, which may be connected to external system(s) 48 (e.g., wagering-game networks).

The external system 48 includes, in various aspects, a gaming network, other gaming machines or terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external-system interface 46 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 48 such that the gaming machine 10 operates as a thin, thick, or intermediate client. The game-logic circuitry 28—whether located within (“thick client”), external to (“thin client”), or distributed both within and external to (“intermediate client”) the gaming machine 10—is utilized to provide a wagering game on the gaming machine 10. In general, the main memory 32 (comprising one or more memory devices) stores programming for an RNG, game-outcome logic, and game assets (e.g., art, sound, etc.). When a wagering-game instance is executed, the CPU 30 (comprising one or more processors or controllers) executes the RNG programming to generate one or more pseudo-random numbers. The pseudo-random numbers are utilized by the CPU 30 when executing the game-outcome logic to determine a resultant outcome for that instance of the wagering game. The resultant outcome is then presented to a player of the gaming machine 10 by accessing the associated game assets, required for the resultant outcome, from the main memory 32. The CPU 30 causes the game assets to be presented to the player as outputs from the gaming machine 10 (e.g., audio and video presentations).

The gaming machine 10 may include additional peripheral devices or more than one of each component shown in FIG. 2. Any component of the gaming-machine architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

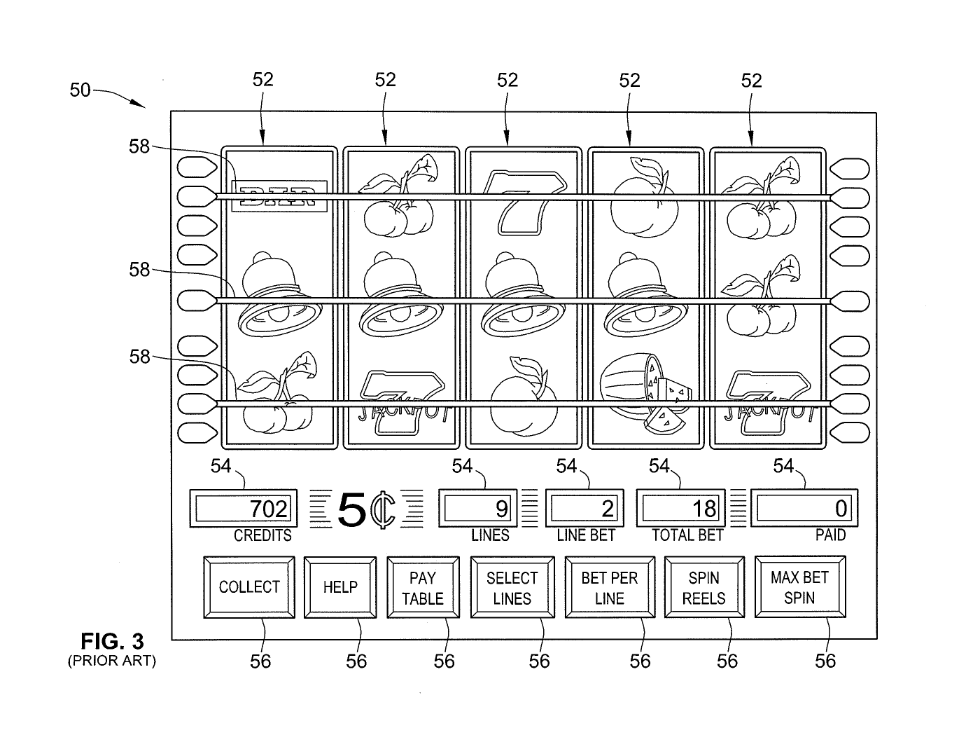

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The game-logic circuitry 28 operates to execute a wagering-game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 12 or secondary display 14) through the display of information such as, but not limited to, text, graphics, static images, moving images, etc., or any combination thereof. In accord with the method of conducting the wagering game, the game-logic circuitry 28 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 28 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 30 causes the recording of a digital representation of the wager in one or more storage media (e.g., storage unit 44), the CPU 30, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU 30 (e.g., the wager in the present example). As another example, the CPU 30 further, in accord with the execution of the stored instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 28 to determine the outcome of the wagering-game instance. In at least some aspects, the game-logic circuitry is configured to determine an outcome of the wagering-game instance at least partially in response to the random parameter.

Gaming machine 10, or a gaming system in which gaming system 10 is implemented, includes a reel controller that drives (via a reel driver) one or more reels 12 (see FIG. 1). The reel controller manages the reel driver to drive the reel(s) based on motion parameters assigned to a time period associated with a spin profile for the reel(s). These motion parameters may be assigned to the start and finish of a selected time period. Motion parameters for a reel spin include those parameters that are used to control, manage, or establish motion of the reel spin according to a spin profile. The motion parameters may include velocity or acceleration values at a given time or times selected from points on a spin profile. For example, the reel controller provides to the reel driver paired motion parameters, where each paired motion parameter is correlated to a start and a finish of one of a set of time periods. These paired motion parameters may include a velocity at the start of the time period and a velocity at the finish of the time period along with an acceleration profile (e.g., linear, etc.).

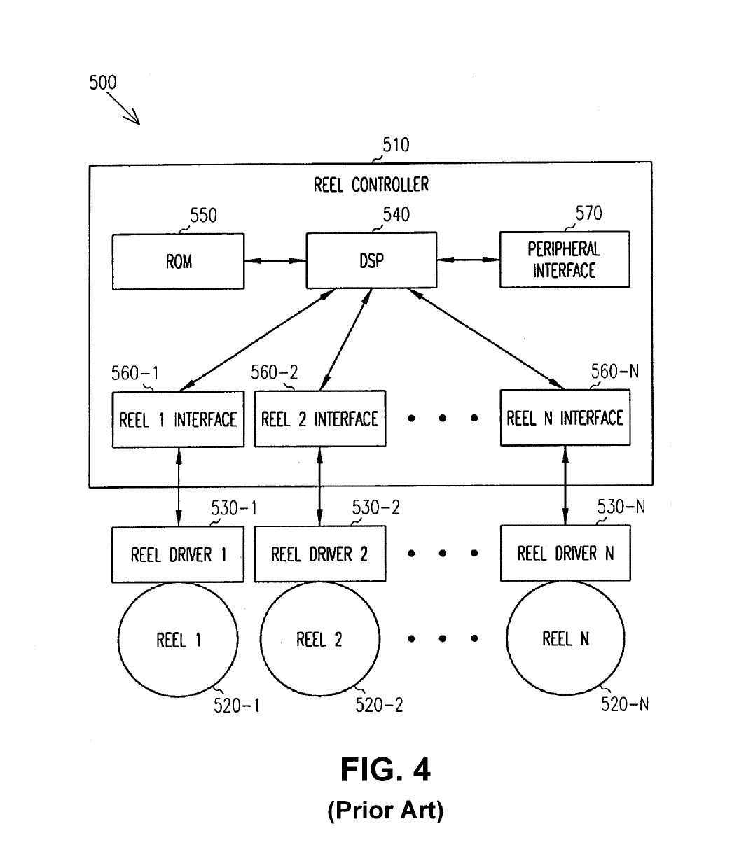

FIG. 4 depicts a block diagram of a non-limiting example of an embodiment of a gaming machine 500 on which the present concepts can be implemented. As shown, the gaming machine 500 has a reel controller 510, a number of reels 520-1, 520-2, . . . 520-N, and a number of reel drivers 530-1, 530-2, . . . 530-N in which reel controller 510 uses spin profiles to manage the operation of the number of reels 520-1, 520-2, . . . 520-N, where N may represent any integer (e.g., 1, 2, 3, 4, 5, etc.). Controller 510 includes one or more processor(s) 540 and a memory 550 that correlate motion parameters to realize spin profiles associated with a game conducted on the gaming machine 500. Memory 550 comprises one or more local and/or remote physical memory device(s) bearing instructions and/or data. Each reel driver 530-1, 530-2, . . . 530-N is responsive to reel controller 510, which may be disposed locally or remotely, to drive a corresponding one of the reel(s) 520-1, 520-2, . . . 520-N based on motion parameters assigned to a time period associated with a spin profile for each reel, via one or more corresponding reel interface(s) 560-1, 560-2, . . . 560-N.

In the example shown in FIG. 4, reel controller 510 includes a peripheral interface 570 (see, e.g., I/O bus 36 in FIG. 2) to receive information (e.g., information regarding motion parameters for each of the reels 520-1, 520-2, . . . 520-N, wherein N represents any integer, such as 2, 3, 4, 5, etc.) and/or instructions from a source external to the reel controller 510 (see, e.g., CPU 30 and/or external systems 48 in FIG. 2). Each reel 520-1, 520-2, . . . 520-N is driven by one of a number of reel drivers 530-1, 530-2, . . . 530-N, respectively, with each reel driver 530-1, 530-2, . . . 530-N being responsive to a reel controller 510. Each reel driver 530-1, 530-2, . . . 530-N may be coupled directly to reel controller 510, coupled to reel controller 510 through a reel interface that handles a number of reel drivers, or coupled to reel controller through a number of reel interfaces with one reel interface per reel driver. In at least some aspects, CPU 30 (see FIG. 2) and/or a controller associated with the external systems 48 (see FIG. 2) may perform calculations in real-time or “on the fly” to provide velocity, acceleration, and/or delay time data to reel controller 510 to provide a control spin reel profile. In other aspects, the control spin reel profile for each reel, game and/or game mode is stored in memory (e.g., main memory 32 or a physical memory device operatively associated with external systems 48 in FIG. 2) and is downloaded by the CPU (e.g., in real-time, or cached in preparation for one or more upcoming game state(s)) and applied to reel controller 510 to drive each reel 520-1, 520-2, . . . 520-N according to the specific spin reel profile for each spin reel.

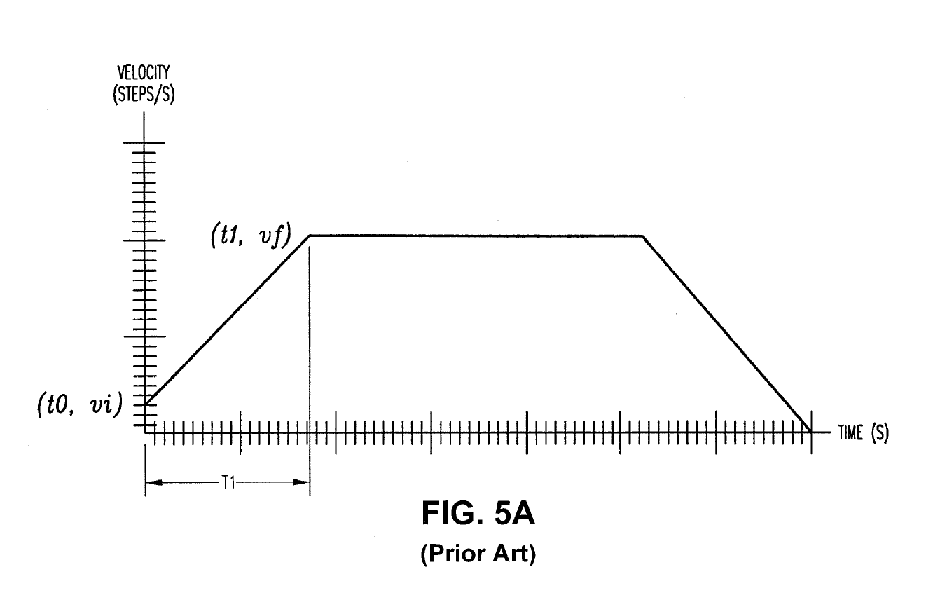

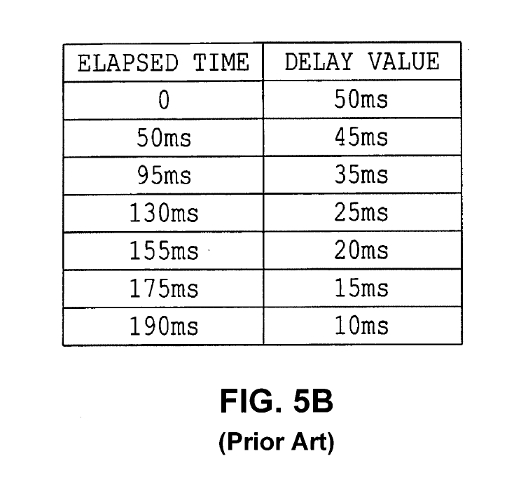

FIG. 5A shows a conventional spin profile velocity-time curve showing velocity of a reel at all times during a spin sequence and FIG. 5B shows a table of delay values corresponding to the acceleration sequence of the reels to produce the velocity-time curve of FIG. 5A. As shown in FIG. 5A, the reel initially sits at rest. The reel controller is commanded, at t=0, to instantaneously begin spinning at initial velocity, vᵢ. The reel velocity is increased linearly over the period T₁ until the final velocity v_{f} is reached. The reel then spins for a predetermined period of time at velocity v_{f} until it is decelerated, coming to rest at the reel stop position chosen by the game controller. Traditionally, during the acceleration and deceleration phases the step rate is controlled by a microprocessor through the use of a lookup table stored in memory, the lookup table containing entries representing the amount of time to delay between each step. By shortening the time from one step to the next the reel will accelerate. By holding the time constant from one step to the next the reel will run at a constant velocity. By lengthening the time from one step to the next the reel will decelerate.

As shown in FIG. 5B, at time t=0, the controller issues a step pulse to the motor controller. The controller then obtains the first delay time value from the lookup table, 50 ms in the table of FIG. 5B. The controller uses this delay time to set a timer. When the timer expires, another step pulse is issued, the next delay value is fetched from the lookup table, and the timer is reset using this fetched delay time. This sequence continues until the end of the table is reached. This scheme is limited to a single acceleration or deceleration profile per table. In order to achieve fine control, these tables may grow to be quite large. The number and size of these tables is limited by the storage capacity of the memory accessed by the controller.

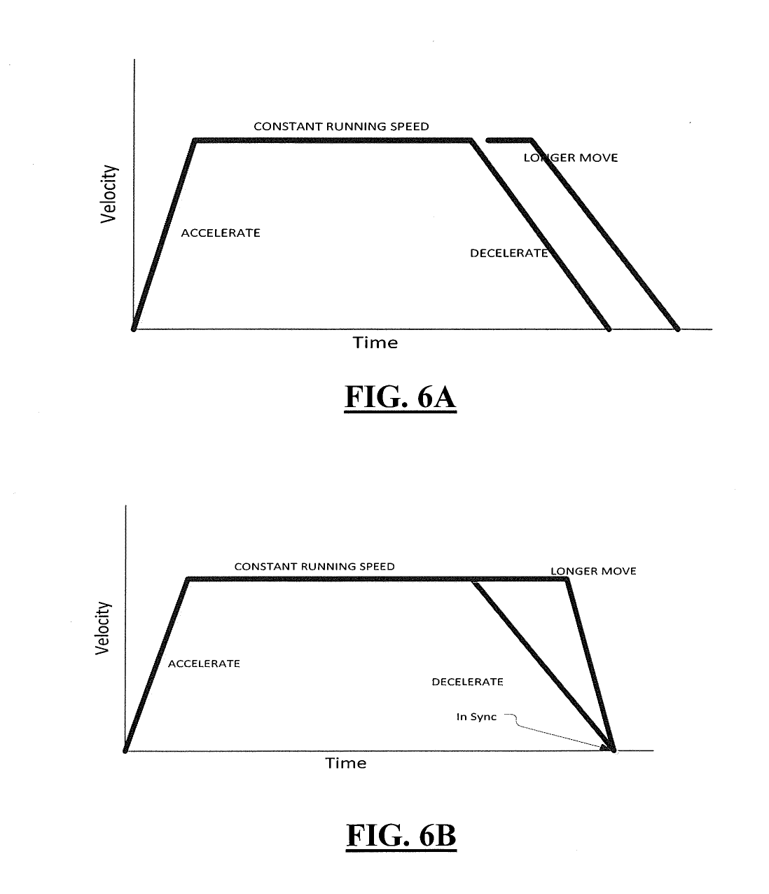

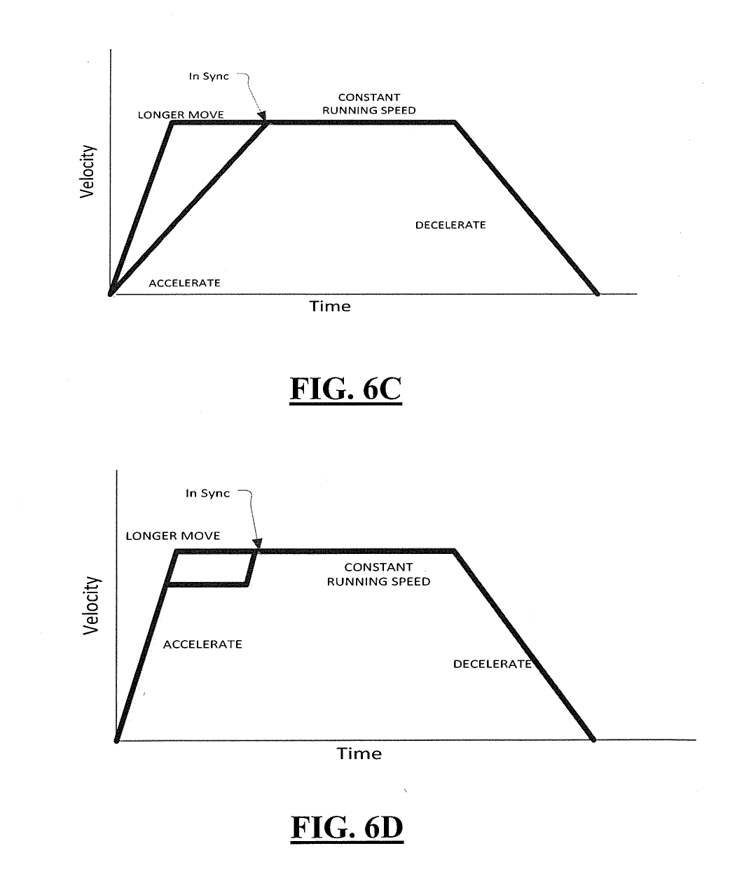

FIGS. 6A-6D show conventional variants of the spin profile velocity-time curve shown in FIG. 5A. The integral of velocity is distance, and the area under the velocity curve represents the total distance the reel moves from start to stop. Longer distance moves are commonly achieved by lengthening the constant running speed portion of the motion, such as is shown in FIG. 6A. To create a fixed (or specified) time duration profile, so that different reel spin profiles would cause a reel to arrive at the same point at the same time (e.g., the “in sync” point for the two reel spin profiles depicted in FIG. 6B), a more detailed control over the complete motion profile is required.

As shown in FIG. 6B, both reel spin profiles will stop at the same time (the “in sync” point), but the reel spin profile denoted as “Longer Move” will travel farther than the other reel spin profile since the area under the curve is greater. Adjusting the slopes of the acceleration and deceleration values in the start profile and/or the stop profile allows control over both the distance moved and the total time duration. A disadvantage of this approach that when it is applied to multiple reels, the only time they are “in sync”, or lined up, is when they stop.

If the acceleration slope is adjusted in a multiple reel system, such as is shown in the reel spin profiles of FIG. 6C, all the reels will be in sync once they all achieve the constant running speed portion of the motion profile. FIG. 6C shows two reel spin profiles, starting at the same initial time, with the first reel spin profile labeled “longer move” being shown to have a more rapid acceleration, and earlier attainment of the constant running speed, than that of the second reel spin profile, which has a more gradual acceleration than that of the first reel spin profile. At the “in sync” point, both profiles have the same constant running speed. A significant disadvantage of these reel spin profiles lies in the limited adjustment sensitivity. By way of example, with respect to one “standard” reel speed, the acceleration time would need to vary from a minimum of about 0.12 seconds up to about 1.26 seconds to achieve the desired reel spin profiles that provide enough adjustment to sync two reels that were at the maximum rotational distance apart, which would be very noticeable to the player.

Another method involves altering the conventional linear start profile, such as is shown in FIG. 6D, by stopping acceleration at an intermediate speed lower than that of the constant running speed, maintaining the intermediate speed for a predetermined time, and the accelerating the reel up to the constant running speed. The value of the intermediate constant running speed and/or the duration of time running at that intermediate constant running speed may be adjusted to reduce the area under the curve and, hence, shorten the distance moved.

As discussed below, the present concepts enable the wagering game designer to specify how the reel comes up to speed (“start profile”), the running speed of the reel (one or more “constant running speeds”), and the manner in which the reels will slow to a stop at the target position (“stop profile”). A reel spin profile, or motion profile, describes the complete motion commanded to the reel by the reel controller from start to finish.

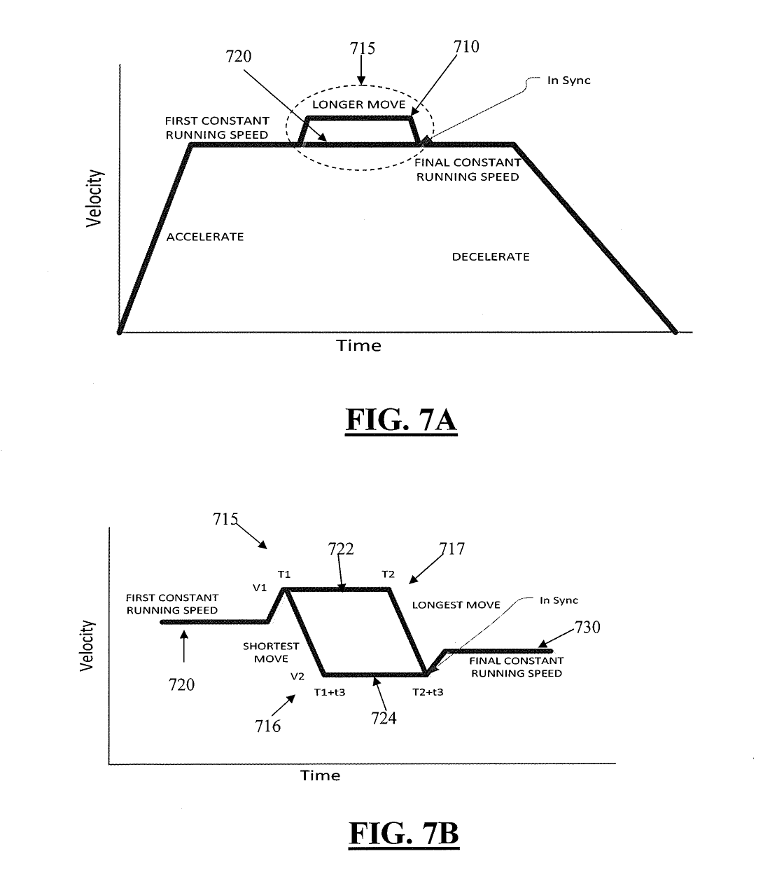

FIG. 7A shows spin profile velocity-time curves in accord with at least some aspects of the present concepts. In a first reel spin profile 720 of FIG. 7A, the reel controller causes the reel to accelerate up to a constant running speed prior to application of a reel spin adjustment algorithm, or reel spin adjustment profile, to change the reel spin profile (denoted by region 715) relative to a base reel spin profile (or relative to a reel spin profile executed on another reel, such as an adjacent reel). By way of example, the reel controller may apply the same reel spin adjustment profile across all the reels in the system, but with different adjustment parameters to achieve the desired synchronization of the reels. The reel spin adjustment algorithm or profile shown in FIG. 7A shows, decelerate back down to the constant running speed following application of the reel spin adjustment algorithm (or algorithms), and then initiate a predetermined stopping profile following the return to the constant running speed. The reel spin adjustment algorithm implements adjustments to the velocity of a reel, via accelerations and decelerations, to adjust a distance that the reel travels in a given period of time. Accordingly, the reel spin adjustment algorithm may be alternatively thought of as a speed or position correction algorithm.

Once the reel has been commanded to stop, the reel controller inserts a time delay before starting the deceleration. The total distance moved during the stop profile is known ahead of time, so the reel controller initiates the stop profile when the reel moves to a position that known distance ahead of the target position. This ensures that the reel stops at the targeted position. In a second reel spin profile 720 in FIG. 7A, the reel controller causes the reel to accelerate up to a constant running speed and, following a predetermined time at the constant running speed (and without application of a reel spin adjustment algorithm), initiates a predetermined stopping profile. In accord with such aspects of the present concepts, the reel spin adjustment algorithm 715 is applied at any time after all the reels have reached the first constant running speed.

In other aspects of the present concepts, more than one reel spin adjustment algorithm 715 may be applied, or the same reel spin adjustment algorithm 715 may be applied more than one time. By way of example, instead of application of one reel spin adjustment algorithm 715, as shown in FIG. 7A, two reel spin adjustment algorithms could be applied (e.g., sequentially). In such an aspect of the present concepts, a reel controller causes a reel to accelerate up to a constant running speed prior to a first adjustment in which a first reel spin adjustment algorithm is applied to accelerate the reel up to a second constant running speed, hold the reel at the second constant running speed for a predetermined time, then decelerate the reel back down to the constant running speed.

Following this first adjustment and the return to the constant running speed, the reel controller applies a second adjustment in which a second reel spin adjustment algorithm is applied (e.g., the second reel spin adjustment algorithm could be the same as the first reel spin adjustment algorithm or different therefrom in one or more aspects of velocity, acceleration, deceleration, and/or time) to accelerate the reel up to a third constant running speed, hold the reel at the third constant running speed for a predetermined time, then decelerate the reel back down to the constant running speed. At some point following the return to the constant running speed, the reel controller initiates a predetermined stopping profile.

Further, it is to be noted that the present concepts do not require the initial constant running speed (i.e., the constant running speed immediately following the initial acceleration phase) to be the same as the final constant running speed (i.e., the constant running speed immediately preceding the deceleration phase). The initial constant running speed may be different than the final constant running speed. The present concepts do contemplate that every reel uses the same speed in certain regions, and the same stop profiles, to maintain synchronization. Thus, in some embodiments, where an initial constant running speed is different than a final constant running speed for a plurality of reels, all of the reels will have the same initial constant running speed and all of the reels will have the same final constant running speed, but may have different adjustments and different intermediate running speeds.

Additionally, although FIG. 7A shows that the reel spin adjustment algorithm 715, which could alternatively be viewed as a position correction algorithm, utilizes an increase in velocity from the first constant running speed to a higher, second running speed for a period of time, the present concepts also include a reel spin adjustment algorithm utilizing a decrease in velocity from the first constant running speed to a lower, second running speed for a period of time, following which the reel speed is increased back to the final constant running speed.

Further, although FIG. 7A shows a single iteration of a reel spin adjustment algorithm 715, wherein the reel controller increases a velocity of the reel from the first constant running speed to a higher, second constant running speed for a period of time, the present concepts also include application of another iteration of a reel spin adjustment algorithm on top of the first iteration. Thus, following the reel's attainment of the second constant running speed, the reel is further accelerated, this time to a third constant running speed. Following attainment of the third constant running speed, the reel spin adjustment algorithm may decelerate the reel back to the second constant running speed (i.e., returning to the first reel spin adjustment algorithm) or may directly decelerate back to the first constant running speed.

An advantage to the application of the reel spin adjustment algorithm(s) during the constant running speed portion of the spin profile, in accord with the present concepts, is that it allows for maximum flexibility of the startup and stopping behavior of the reels and the adjustment process is independent of the startup and stopping behavior, allowing for more complicated start and stop profiles such as oscillations, variable accelerations, overshoot, and the like.

An example of a reel spin adjustment algorithm 715 in accord with at least some aspects of the present concepts is shown in FIG. 7B. In FIG. 7B, the difference between the shortest reel spin adjustment profile 716 and the longest reel spin adjustment profile 717 is the amount of reel offset the algorithm(s) can inject. Also as shown in FIG. 7B, it is to be noted that the first constant running speed 720 and the second, final constant running speed 730 are not the same, nor do they need to be the same as the adjustment speed V1 (722) and adjustment speed V2 (724). Time T1 is the initial time at which the adjustment speed V1 (i.e., the adjusted constant running speed), and T2 is the latest time at which the adjustment speed V1 is maintained. Time “t3” defines the amount of time needed to change from adjustment speed V1 to adjustment speed V2 and does not affect the adjustment value. Graphically, the parallelogram in FIG. 7B defines the adjustment amount, wherein the area of the parallelogram is the adjustment. Stated different, the value of the time adjustment is given by the following relation:

Position Adjustment=(V1−V2)*(T2−T1)

As one example, wherein V1 is 750 steps/second, V2 is 650 steps/second, and (T2−T1)=4 seconds, the position adjustment is 400 steps. It is to be understood that the parallelogram depicted in FIG. 7B is exemplary and other profiles can be used in accord with various aspects of the present concepts. By way of example, in lieu of the constant running speeds between points T1 to T2 (or T1+t3 to T2+t3), a curvilinear profile, or approximation thereof (e.g., a stepped profile approximating that of a curve), could be utilized.

In accord with the present concepts, multiple reels may be started spinning at the same time and, while still spinning, a predetermined combination of symbols (e.g., a winning symbol combination) come into alignment, following which the reels are simultaneously stopped.

In accord with the present concepts, the reels can not only be stopped in a predetermined time sequence, but also at the correct positions. This is accomplished by control of the duration of a reel spin independently of the distance the reel needs to spin to reach its target position. The distance that the reel needs to spin is adjusted by application of one or more reel spin adjustment algorithms between the start and stop profiles.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the present invention. By way of example, the present concepts include application of a plurality of different, distinct profiles even to a single reel. In one illustration, reel controller(s) cause a reel driver to drive (i.e., accelerate or decelerate) a mechanical reel, following attainment of the first constant running speed, to a second constant running speed in accord with a first reel spin adjustment profile and then to drive the mechanical reel back to the first constant running speed. After this operation, the reel controller(s) cause the reel driver to drive (i.e., accelerate or decelerate) the mechanical reel to a third constant running speed in accord with a second reel spin adjustment profile and then to drive the first mechanical reel back to one of the second constant running speed or first constant running speed.

It is to be understood that the above description is intended to be illustrative, and not restrictive, and that the phraseology or terminology employed herein is for the purpose of description and not of limitation. Combinations of the above embodiments, and other embodiments, will be apparent to those of skill in the art upon studying the above description. The scope of the present invention includes any other applications in which the above structures and fabrication methods are used. The scope of the present invention should be determined with reference to the appended claims, along with the full scope of equivalents to which such claims are entitled.

1. A wagering game system configured to conduct a wagering game, the wagering game system comprising:
one or more input devices;
one or more reel controllers;
a plurality of mechanical reels, each of the plurality of mechanical reels bearing a plurality of symbols used to display a determined outcome of the wagering game and each of the plurality of mechanical reels being independently driven by a respective reel driver responsive to control inputs from the one or more reel controllers; and
game-logic circuitry, comprising one or more central processing units and one or more memory devices, the one or more physical memory devices storing instructions that, when executed by the one or more central processing units, cause the game-logic circuitry and the one or more reel controllers, as appropriate, to:
register an input from at least one of the one or more input devices as an indication of a wager to conduct the wagering game;
cause each reel driver to accelerate a respective one of the plurality of mechanical reels to a first constant running speed in accord with a start profile assigned to the respective mechanical reel;
cause at least a first reel driver to drive a first reel mechanical reel of the plurality of mechanical reels, following attainment of the first constant running speed, to a second constant running speed in accord with a first reel spin adjustment profile and then to drive the first mechanical reel back to the first constant running speed; and
following the driving of the first mechanical reel back to the first constant running speed, cause each reel driver to decelerate a respective mechanical reel from the first constant running speed to a stop using a common stop profile to display the outcome of the wagering game.

2. The wagering game system of claim 1, wherein the one or more reel controllers are further configured to cause the first reel driver to accelerate the first mechanical reel, following attainment of the first constant running speed, to a higher second constant running speed in accord with a first reel spin adjustment profile and then to decelerate the first mechanical reel back to the lower first constant running speed.

3. The wagering game system of claim 1, wherein the one or more reel controllers are further configured to cause the first reel driver to decelerate the first mechanical reel, following attainment of the first constant running speed, to a lower second constant running speed in accord with a first reel spin adjustment profile and then to accelerate the first mechanical reel back to the higher first constant running speed.

4. The wagering game system of claim 2, wherein the one or more reel controllers are further configured to cause a second reel driver to drive a second reel mechanical reel of the plurality of mechanical reels, following attainment of the first constant running speed, to a third constant running speed in accord with a second reel spin adjustment profile and then to drive the second mechanical reel back to the first constant running speed; and
following the driving of the each mechanical reels, inclusive of the first mechanical reel and the second mechanical reel, back to the first constant running speed, cause each reel driver to decelerate a respective mechanical reel from the first constant running speed to a stop using a common stop profile to display the outcome of the wagering game.

5. The wagering game system of claim 4, wherein a start profile for each of the plurality of mechanical reels is a common start profile.

6. The wagering game system of claim 4, wherein the second constant running speed is different than the third constant running speed.

7. The wagering game system of claim 4, wherein the one or more reel controllers are further configured to cause a third reel driver to drive a third reel mechanical reel of the plurality of mechanical reels, following attainment of the first constant running speed, to a fourth constant running speed in accord with a third reel spin adjustment profile and then to drive the third mechanical reel back to the first constant running speed; and
following the driving of the each mechanical reels, inclusive of the first through third mechanical reels, back to the first constant running speed, cause each reel driver to decelerate a respective mechanical reel from the first constant running speed to a stop using a common stop profile to display the outcome of the wagering game.

8. The wagering game system of claim 1, wherein the game-logic circuitry and one or more reel controllers are, via execution of the instructions stored on the one or more physical memory devices by the one or more central processing units, are further configured to:
cause the first reel driver to drive the first reel mechanical reel, following attainment of the first constant running speed, to the second constant running speed in accord with the first reel spin adjustment profile and then to drive the first mechanical reel back to the first constant running speed following lapse of a predetermined first period of time;
cause a second reel driver to drive a second mechanical reel, following attainment of the first constant running speed, to a third constant running speed in accord with a second reel spin adjustment profile and then to drive the second mechanical reel back to the first constant running speed following lapse of a predetermined second period of time; and
cause all reel drivers to decelerate respective mechanical reels from the first constant running speed to a stop using a common stop profile to display the outcome of the wagering game,
wherein a second total distance traveled by the second mechanical reel is different than a first total distance traveled by the first mechanical reel.

9. The wagering game system of claim 8, wherein the predetermined first period of time is different than the predetermined second period of time.

10. The wagering game system of claim 8, wherein the second constant running speed is different than the third constant running speed.

11. The wagering game system of claim 1, wherein at least one of the common start profile and the common stop profile comprises at least one of an oscillation, a variable acceleration or deceleration, or an overshoot.

12. A gaming machine configured to conduct a wagering game comprising:
one or more input devices to receive inputs to play the wagering game;
a first reel controller;
a first mechanical reel on which a plurality of wagering game symbols associated with the game are portrayed;
a first reel driver responsive to a plurality of drive signals from the first reel controller to drive the first mechanical reel based on motion parameters associated with a spin profile for the first mechanical reel, the motion parameters including a start profile, a motion profile, and a stop profile;
one or more processors;
one or more memory devices operatively coupled to the one or more processors via a data bus, wherein information regarding the motion parameters is provided to the first reel controller using the data bus,
wherein the motion parameter start profile comprises acceleration of the first mechanical reel from a stop to a first constant running speed,
wherein the motion parameter motion profile for the first mechanical reel comprises one of acceleration or deceleration of the first mechanical reel from the first constant running speed to a second constant running speed, maintenance of the second constant running speed for a second predetermined period of time, and a corresponding other one of deceleration or acceleration of the first mechanical reel, as appropriate, back to the first constant running speed following lapse of the second predetermined period of time, and
wherein the motion parameter stop profile comprises deceleration of the first mechanical reel from the first constant running speed to a stop to display the contribution of the first mechanical reel's displayed wagering game symbols to the outcome of the wagering game.

13. The gaming machine according to claim 12, wherein the motion parameter motion profile comprises acceleration of the first reel from the first constant running speed to the second constant running speed, maintenance of the second constant running speed for the second predetermined period of time, and deceleration of the first reel from the second constant running speed back to the first constant running speed.

14. The gaming machine of claim 12, further comprising:
one or more reel controllers, the one or more reel controllers comprising the first reel controller;
a plurality of mechanical reels, the plurality of mechanical reels comprising at least the first mechanical reel and a second mechanical reel, on each of which a plurality of wagering game symbols associated with the wagering game are portrayed;
at least a first reel driver and a second reel driver, each of the reel drivers being responsive to a plurality of drive signals from the one or more reel controllers to drive a respective one of the first and second mechanical reels in accord with motion parameters governing a spin profile for the respective mechanical reel, the motion parameters including a start profile, a motion profile, and a stop profile; and
one or more memory devices operatively coupled to the one or more processors via one or more data busses, wherein information regarding the motion parameters is provided to the one or more reel controllers using the one or more data busses,
wherein, for each of the mechanical reels, the motion parameter start profile comprises acceleration of the mechanical reel from a stop to the first constant running speed,
wherein, for the second mechanical reel, the motion parameter motion profile comprises one or acceleration or deceleration of the second mechanical reel from the first constant running speed to a third constant running speed, maintenance of the second mechanical reel at the third constant running speed for a third predetermined period of time, and a corresponding other one of deceleration or acceleration of the second mechanical reel, as appropriate, to the first constant running speed following lapse of the third predetermined period of time, and
wherein, for each of the plurality of mechanical reels, the motion parameter stop profile comprises deceleration of the mechanical reel from the first constant running speed to a stop to display the contribution of the mechanical reel's displayed wagering game symbols to the outcome of the wagering game.

15. The gaming machine of claim 14, wherein
wherein the second predetermined period of time of the motion parameter motion profile for the first mechanical reel is different than the third predetermined period of time of the motion parameter motion profile for the second mechanical reel.

16. The gaming machine of claim 15, wherein
wherein the second constant running speed of the motion parameter motion profile for the first mechanical reel is the same as the third constant running speed of the motion parameter motion profile for the second mechanical reel.

17. The gaming machine of claim 14, further comprising:
one or more reel controllers comprising at least the first reel controller;
a plurality of reels, comprising the first reel, the second reel, and a third reel, on each of which a plurality of wagering game symbols associated with the game are portrayed;
a plurality of reel drivers, each of the plurality of reel drivers being responsive to a plurality of drive signals from the one or more reel controllers to drive a respective one of the plurality of reels in accord with motion parameters governing a spin profile for the reel, the motion parameters including a start profile, a motion profile, and a stop profile;
one or more memory devices operatively coupled to the one or more central processing units via one or more data busses, wherein information regarding the motion parameters is provided to the one or more reel controllers using the one or more data busses,
wherein, for each of the plurality of reels, the motion parameter start profile comprises acceleration of the reel from a stop to the first constant running speed,
wherein, for a second reel of the plurality of reels, the motion parameter motion profile comprises one or acceleration or deceleration of the reel from the first constant running speed to the second constant running speed, or to a third constant running speed different from the second constant running speed, maintenance of the second constant running speed or third constant running speed, as appropriate, for a third predetermined period of time, and a corresponding other one of deceleration or acceleration of the reel, as appropriate, to the first constant running speed following lapse of the third predetermined period of time, and
wherein, for each of the plurality of reels, the motion parameter stop profile comprises deceleration of the reel from the first constant running speed to a stop to display the contribution of the reel's displayed wagering game symbols to the outcome of the wagering game.

18. A method for conducting a wagering game on a wagering game system comprising a wagering game machine having an input device to receive a wager to play the wagering game and having a plurality of mechanical reels, each of the plurality of mechanical reels portraying a plurality of symbols associated with the wagering game, the method including the acts of:
determining an outcome of the wagering game using one or more processors;
providing a set of motion parameters to a mechanical reel controller of the wagering game machine, the set of motion parameters including one or more start profiles, a plurality of motion profiles, and one or more stop profiles;
determining, using the one or more processors, a set of motion parameters for each of the plurality of mechanical reels that will collectively place each of the plurality of mechanical reels in sync prior to execution of the one or more stop profiles so that each of the plurality of mechanical reels is positioned relative to one another, during rotation, to display a determined outcome of the wagering game;
driving each of the plurality of mechanical reels in accord with a respective one or more of the one or more start profiles;
driving each of the plurality of mechanical reels in accord with a respective one or more of the plurality of motion profiles; and
stopping each of the plurality of mechanical reels in accord with a respective one or more of the one or more stop profiles at a point in time after the plurality of mechanical reels are in sync.

19. The method of claim 18, wherein a motion profile for a first mechanical reel comprises an acceleration of the first mechanical reel from the base constant running speed to a second constant running speed, maintenance of the second constant running speed for a second predetermined period of time, and a deceleration of the first mechanical reel to the base constant running speed following lapse of the second predetermined period of time, and
wherein a motion profile for a second mechanical reel comprises an acceleration of the second mechanical reel from the base constant running speed to a third constant running speed, maintenance of the third constant running speed for a third predetermined period of time, and a deceleration of the second mechanical reel to the base constant running speed following lapse of the third predetermined period of time.

20. The method of claim 18, wherein a motion profile for a first mechanical reel comprises a deceleration of the first mechanical reel from the base constant running speed to a second constant running speed, maintenance of the second constant running speed for a second predetermined period of time, and an acceleration of the first mechanical reel to the predetermined constant running speed following lapse of the second predetermined period of time, and
wherein a motion profile for a second mechanical reel comprises a deceleration of the second mechanical reel from the base constant running speed to a third constant running speed, maintenance of the third constant running speed for a third predetermined period of time, and an acceleration of the second mechanical reel to the base constant running speed following lapse of the third predetermined period of time.

21. (canceled)
